(19) United States
(12) Patent Application Publication
(10) Pub. No.: US 2020/0092115 A1
(43) Pub. Date: Mar. 19, 2020

(54) Automated Certificate Management for Automation Installations

(71) Applicant: Siemens Aktiengesellschaft, Muenchen (DE)

(72) Inventors: Anna Palmin, Karlsruhe (DE); Benjamin Lutz, Pfinztal (DE)

(73) Assignee: Siemens Aktiengesellschaft

(21) Appl. No.: 16/569,284

(22) Filed: Sep. 12, 2019

(30) Foreign Application Priority Data
Sep. 13, 2018 (EP) 18194247.5

(51) Int. Cl. H04L 9/32; G05B 11/01

(52) U.S. Cl. CPC H04L 9/3268; G05B 11/01

(57) ABSTRACT

A service function of a control system of a technical installation, which is established to function as an intermediary between at least one registration authority of the technical installation and at least one installation component during certificate requests by the at least one installation component, wherein the at least one installation component is already part of the technical installation or is provided for integration into the technical installation, where the service function acting as an intermediary at least involves identifying a registration authority of the technical installation responsible for the at least one installation component and forwarding a certificate request of the at least one installation component to the corresponding registration authority, and where the registration authority forwards the certificate request to a certification authority of the technical installation.

### BACKGROUND OF THE INVENTION

### 1. Field of the Invention

The invention relates to a software database for a public key infrastructure of a technical installation, in particular manufacturing or process installation, which comprises at least one unique identification of installation components involved in the technical installation, to a service function of a control system of a technical installation, to a control system of the technical installation, to the technical installation, to a method for applying for a certificate at a registration authority of the technical installation on the part of a component of the technical installation and to a method for issuing a certificate on the part of a certification authority of the technical installation.

### 2. Description of the Related Art

As part of a public key infrastructure of a technical installation, “registration services” (also known as “registration authorities”) are used to accept certificate requests (also known as “certificate signing requests” (“CSR”)) from devices or other components of the technical installation and to forward them to a certification authority for validation.

The certificate requests may involve requests to initially apply for (bootstrapping) or renew (update) certificates. During bootstrapping, the certificate request is generally signed with the manufacturer device certificate (MDC)) while during updating, the last-issued operational certificate (OC) is used for signing. As an alternative or in addition to the device certificate, which is issued during manufacturing of the device by a certification authority of the manufacturer of the device, it is possible for the “customer device certificate” (CDC) to be used. This involves a certificate that the corresponding device has obtained after being checked in the technical installation. In order for the registration authority to be able to process the certificate requests, at least one device certificate (and/or one customer certificate) must be available to it (in the case of bootstrapping) and at least one operational certificate (in the case of updating).

The tasks of a registration authority may, depending on the size of the installation and further boundary conditions, be undertaken by both a dedicated registration authority and also by established software tools, such as engineering or runtime tools. While a dedicated registration authority, which is available both during engineering and subsequently at runtime of the installation, may be advantageous for a large technical installation, the integration of the functionalities of the registration authority into established software tools or installation components lends itself for smaller installations.

Installation components may themselves apply for the operational certificates that they require for the utilization of various secure protocols, such as transport layer security (TLS) or OPC Unified Architecture (OPC UA). In this context, an installation component in the role of a client or an applicant directs its certificate request to a particular registration authority, which validates the request and forwards the result to a certification authority, which is located within the installation (“on-site CA”) or in a trust center (“off-site CA” or “CA as a service”) for example. In this context, it is possible to store the address of the registration authority (for example, in the form of a uniform resource locator (URL) in a configuration file of the installation component itself.

In most installations, an engineering tool, such as what is known as the “TIA Portal” of the company Siemens, which has been used for the initial rolling-out of certificates during engineering, is no longer available at runtime of the technical installation. The certificates, in particular the operational certificates, only have a limited validity period. Accordingly, the certificate nevertheless need to be able to be renewed at runtime.

In principle, the certificate renewal could be undertaken by another adequate “runtime tool”. This, however, is associated with the following problems:

As already explained above, a certificate request, which is directed at a certificate renewal, is generally signed by the certificate to be renewed itself. The registration authority, which is to validate the renewal request, thus has to be provided with the certificate to be renewed. If the certificate to be renewed was applied for via the engineering tool, however, then it is generally no longer available for the runtime tool.

The installation component applying for a certificate has, as previously explained, information relating to the “correct” registration authority at which it should apply for its certificate. Often, in the engineering phase of the technical installation, the function of a registration authority is undertaken by a component of the engineering tool being used. This component, however, is no longer available or may no longer be available at runtime of the technical installation. Therefore, the information relating to the registration authority stored in the installation component is therefore often no longer able to be utilized at runtime of the technical installation.

### SUMMARY OF THE INVENTION

It is an object of the invention to provide a software database, a service function of a control system and an associated control system, which simplify a certificate application of components of a technical installation both during initiation of the components in an engineering phase and during a renewal procedure of the components at runtime of the installation.

This and other objects and advantages are achieved in accordance with the invention by a software database for a public key infrastructure of a technical installation, in particular manufacturing or process installation, which comprises at least one unique identification of installation components involved in the technical installation, by a service function of a control system of the technical installation, by a control system of the technical installation, in particular manufacturing or process installation, by the technical installation, by a method for applying for a certificate at a registration authority of the technical installation on the part of a component of the technical installation and by a method for issuing a certificate on the part of a certification authority of the technical installation.

A software database for a public key infrastructure of a technical installation, in particular a manufacturing or process installation, which comprises at least one unique identification of installation components involved in the technical installation, is established in accordance with to the invention in that the software database has the following components for at least one installation component, in relation to which a unique identification is stored in the software database: a) a device certificate issued by a manufacturer of the installation component and/or an operator of the technical installation; b) and at least one operational certificate, which has been issued for the installation component in the technical installation.

The technical installation can be an installation from the process industry, such as a chemical, pharmaceutical or petrochemical installation, or an installation from the food and beverage industry. This also encompasses any installations from the production industry, factories in which, for example, automobiles or goods of all kinds are produced. Technical installations that are suitable for implementing the inventive method can also come from the power generation sector. The term “technical installation” also encompasses wind turbines, solar installations or power generation plants.

These installations each have a control system or at least a computer-aided module for controlling and regulating the running process or production. Part of the control system or controller module or of a technical installation is at least one software database, in which data can be stored.

Associated with the term “public key infrastructure” (PKI) is a security infrastructure for a technical installation, which provides services for a secure exchange of data between communication partners of the technical installation. With the aid of the public key infrastructure, it is possible to issue, distribute and check certificates.

A certificate is understood to be a digital data record, which confirms certain properties (in this case of machines, devices and/or applications). An authenticity and integrity of the certificate can be verified via cryptographic methods.

The unique identification may, for example, involve a serial number of the installation component. An installation component of this kind may, for example, be a field device, a controller apparatus, on an application.

The software database in accordance with the invention contains at least one certificate issued by a manufacturer of the installation component and/or an operator of the technical installation. In the case of a device, the certificate issued by the manufacturer of the device involves a “device certificate”. In addition, the software database contains at least one operational certificate. An operational certificate of this kind is issued based on the request by an installation component.

By centrally filing the certificates in the software database, it is possible to achieve a higher level of transparency and also an improved ability to be audited and traced for the technical installation.

The above-described objects and advantages are additionally achieved by a service function, in accordance with the invention, of a control system of a technical installation. This is established to act as an intermediary between at least one registration authority of the technical installation and at least one installation component during certificate requests by the at least one installation component, where the at least one installation component is already part of the technical installation or is provided for integration into the technical installation, and where the service function acting as an intermediary at least involves identifying a registration authority of the technical installation responsible for the at least one installation component and forwarding a certificate request of the at least one installation component to the corresponding registration authority, and where the registration authority is configured and provided to forward the certificate request to a certification authority of the technical installation.

In the present context, a control system is understood to be a computer-aided technical installation, which comprises functionalities for representing, operating and controlling a technical manufacturing or production installation. In the present case, the control system comprises sensors for determining measured values, as well as various actuators. Additionally, the control system comprises what are known as process or manufacture-oriented components, which serve to activate the actuators or sensors. Furthermore, the control system has inter alia means for visualizing the technical installation and for engineering. The term control system is additionally intended to also encompass further computer units for more complex regulations and systems for data storage and processing.

A registration authority of the technical installation is understood to be a functional instance, which accepts registration requests as certificate requests from components of the technical installation, checks these and in a successful case forwards these to a certification authority of the technical installation in particular. In the present case, the registration authority is primarily provided for handling certificate requests from installation components of the technical installation.

The service function in accordance with the invention possesses an intermediary function. The service function knows which registration authority is responsible or to be selected for a particular certificate request of a particular installation component. A technical installation regularly has more than one registration authority, so that it is necessary to know the correct registration authority for a particular installation component at a particular time. Here, “correct” means that a particular registration authority, for example, currently has only a low utilization and therefore can process incoming requests quickly. In addition, registration authorities may be unavailable for periods of time, because a connection is interrupted due to a defect.

In accordance with the invention, the service function possesses the information necessary to act as an intermediary between the installation components and the registration authorities. To this end, provision may be made for the registration authorities of the technical installation to actively report at the service function and to transmit their status. It is also possible, however, that the service function automatically starts a query as to which registration authorities are available at particular points in time.

One advantage arising from the invention consists in configuration data of the individual installation components relating to the registration authority to be selected does not need to be updated regularly. In addition, the installation component or a user, who is to integrate the installation component into the technical installation, is relieved of the task of identifying the correct/right registration authority.

Advantageously, the service function is implemented on an operator station server and/or an operator station individual computer. In the present context, an “operator station server” is understood to mean a server that centrally captures data of an operator control and monitoring system and generally also alarm and measured value archives of a control system of a technical installation, and makes this data available to users. In this context, the service function may be implemented on a plurality of computers/servers, in order to achieve a redundancy or higher availability.

The operator station server generally establishes a communication connection to automation systems of the technical installation and forwards data of the technical installation to what are known as clients for the purpose of operator control and monitoring of an operation of the individual function elements of the technical installation. The operator station server can have client functions for accessing the data (archives, messages, tags, variables) of other operator station servers. This means that images of an operation of the technical installation on the operator station server can be combined with variables of other operator station servers (server-server communication). The operator station server can be a SIMATIC PCS 7 industrial workstation server from SIEMENS, without being restricted to this.

In one advantageous embodiment of the service function in accordance with the invention, this is established to perform a mutual coordination of a plurality of registration services of the technical installation, such that a unique allocation between an installation component of the technical installation and a registration service responsible for certificate requests of the installation component can be implemented by the service function. A coordination of this kind may, for example, consist in no further registration authority being registered at the service function, while one registration authority is already characterized as being available.

It is also an object of the invention to provide a control system of a technical installation, in particular manufacturing or process installation, in which at least one software database and one service function are implemented, which are configured as explained above. The intermediary activity of the service function is considerably simplified by the advantageous combination of the software database and the service function. In particular, it does not need to observe whether the chosen registration authority is at all aware of the certificate of the installation component which is making a request. By filing the issued certificates in the software database, these can be retrieved by any registration authority at any time. The filing of the certificates in the software database may occur in this context on the part of the registration authorities or the service function itself. Naturally, it is also possible to connect further or other functions between the chain “certification authority—installation—component”.

It is also an object of the invention to provide a technical installation, in particular manufacturing or process installation, in which at least one control system as explained above is implemented.

The method in accordance with the invention for applying for a certificate at a registration authority of a technical installation on the part of a component of the technical installation comprises a) transferring a certificate request of an installation component to a registration authority, responsible for the installation component, of the technical installation via a service function, which is established as explained above, b) examining by the registration authority whether a certificate attached to the certificate request and issued by a manufacturer of the installation component and/or by an operator of the technical installation, and/or an operational certificate, which has been issued for the installation component in the technical installation, is stored in a software database of the technical installation, which is formed as explained above, c) examining by the registration authority whether a signature of the certification request is correct, and d) examining by the registration authority whether a public key of the certification request matches a public key contained in the certificate issued by a manufacturer of the installation component and/or an operator of the technical installation and/or an operational certificate, which has been issued for the installation component in the technical installation.

The checking in accordance with method step c) involves what is known as a “proof of possession”. In this context, the check is performed to determine whether the signature of the certificate request (also referred to as a “certificate signing request” or (CSR) has been generated by the installation component making the request (using a private key only available to it). If the signature proves to be invalid, then the validation of the installation components is aborted.

The examination of the public keys in accordance with method step d) is also referred to as “proof of origin”.

The registration authority may additionally, as part of the checking process, check whether the installation component that is making the certification request can be assigned to a particular company.

As an alternative or in addition, the registration authority can check, as part of the checking process, the type of installation component and/or whether an intended use of the certificate request is correct.

In a successful case, i.e., on a successful validation of the installation component making the certification request, a corresponding certificate can be issued by the certification authority and transferred both to the corresponding installation component and also to the software database, explained above, of the technical installation. This transfer may, as stated above, be performed by the registration authorities or the service function, for example.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will now be described more clearly and intelligibly in conjunction with the following description of the exemplary embodiment, which will be described in detail making reference to the drawings, in which:

FIG. 1 is a schematic illustration of a part of a control system in accordance with the invention; and

FIG. 2 is a flowchart of the method in accordance with the invention.

### DETAILED DESCRIPTION OF THE EXEMPLARY EMBODIMENTS

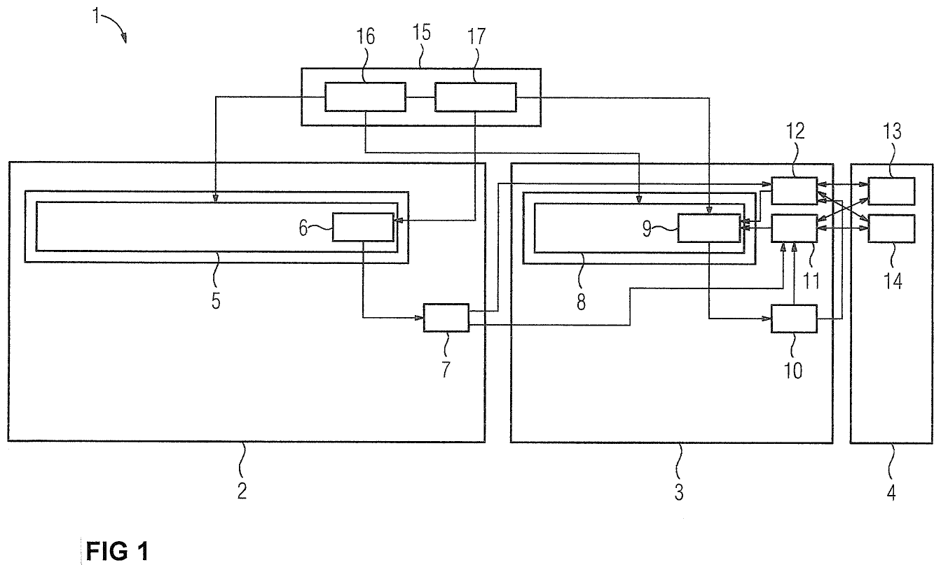

In FIG. 1, a part of a control system 1 in accordance with the invention of a technical installation is shown schematically. The control system 1 comprises an individual computer 2, an operator station server 3 and a further server 4.

Implemented on the individual computer 2 is a web server 5, in which a service function 6 is integrated in turn. In addition, a certification service 7 is implemented on the individual computer.

Implemented on the operator station server 3 is a web server 8, in which a service function 9 is integrated in turn. In addition, a certification service 10 and a first registration authority 11, as well as a second registration authority 12 are implemented on the operator station server 3.

Implemented on the further server 4 are a software database 13 and a certification authority 14.

The control system 1 additionally has a terminal station 15, upon which a display function 16 and a client of a service function 17 are implemented.

With the display function 16, it is possible for a user to display a graphical representation of the services provided by the web servers 5, 8. The service function 17, as client function, accesses the two other service functions 6, 9 established as intermediaries in accordance with the invention. These are combined in a cluster in order to increase availability. Expressed correctly, the client of the service function 17 therefore accesses the cluster.

Provided by the cluster, the current registration authority 11, 12 can be queried via each of the two service functions 6, 9. A certificate request made by the installation component is automatically forwarded to the correct registration authority 11, 12. Connected between the service functions 6, 9 in each case is a certification service 7, 10 that determines the currently available registration authorities 11, 12 and subsequently made a certificate request at the corresponding registration authority 11, 12.

In a successful case, i.e., on successful validation of the installation component, the selected registration authority 11, 12 forwards the certificate request to the certification authority 14 of the technical installation. The certification authority 14 is also referred to as what is known as an “issuing CA (Certification Authority)”. An issuing CA of this kind is generally always online and provides, on the basis of incoming certificate requests, certificates for various applicants, which it signs with its own issuing CA certificate. The trustworthiness of the issuing CA is ensured by its own issuing CA certificate being signed by the certificate of a trustworthy root certification authority (also referred to as “root CA”), which is located in a secure environment. In this context, it should be noted that the root CA is offline for most of the time and is only activated or switched on (while observing the strongest security precautions) when it is to issue a certificate for an associated issuing CA. The root CA may also be located outside the technical installation.

The certificate issued by the certification authority 14 is subsequently transferred to both the installation component and to the software database 13, where it is available for future, further certificate requests within the entire control system 1.

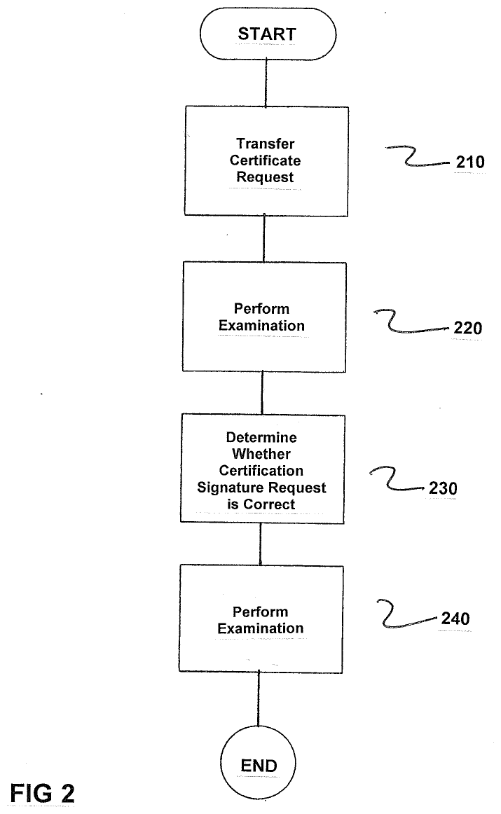

FIG. 2 is a method for applying for a certificate at a registration authority 11, 12 of a technical installation on a part of a component of the technical installation. The method comprises transferring a certificate request of an installation component to a registration authority 11, 12, responsible for the installation component, of the technical installation via a service function 6, 9, as indicated in step 210.

Next, the registration authority 11, 12 performs an examination to determine whether at least one of (A) a certificate attached to the certificate request and issued by at least one of (i) a manufacturer of the installation component and (ii) an operator of the technical installation and (B) an operational certificate, which has been issued for the installation component in the technical installation, is stored in a software database, as indicated in step 220.

Next, the registration authority 11, 12 performs an examination to determine whether a signature of the certification request is correct, as indicated in step 230.

Next, the registration authority 11, 12 performs an examination to determine whether at least one of (A) a public key of the certification request matches a public key contained in the certificate issued by at least one of (i) the manufacturer of the installation component and (ii) the operator of the technical installation and (B) an operational certificate, which has been issued for the installation component in the technical installation, as indicated in step 240.

Although the invention has been illustrated and described in detail using the preferred exemplary embodiment, the invention is not limited by the disclosed examples, and a person skilled in the art can derive other variations therefrom without departing from the scope of protection of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A software database for a public key infrastructure of a technical installation, which comprises at least one unique identification of installation components involved in the technical installation, the software database including information for at least one installation component, in relation to which a unique identification is stored in the software database comprising:
a) a device certificate issued by at least one of (i) a manufacturer of the installation component and (ii) an operator of the technical installation; and
b) at least one operational certificate, which has been issued for the installation component in the technical installation.

2. The software database as claimed in claim 1, wherein the technical installation comprises a manufacturing or process installation.

3. A service function of a control system of a technical installation, which is established to function as an intermediary between at least one registration authority of the technical installation and at least one installation component during certificate requests by the at least one installation component;
wherein the at least one installation component is already part of the technical installation or is provided for integration into the technical installation; and
wherein the service function acting as an intermediary at least involves identifying a registration authority of the technical installation responsible for the at least one installation component and forwarding a certificate request of the at least one installation component to the corresponding registration authority; and
wherein the registration authority is established and provided to forward the certificate request to a certification authority of the technical installation.

4. The service function as claimed in claim 2, wherein the service function is implemented on at least one of (i) at least one operation station server and (ii) an operator station individual computer.

5. The service function as claimed in claim 2, wherein the service function performs a mutual coordination of a plurality of registration services of the technical installation, such that a unique allocation between an installation component of the technical installation and a registration service responsible for certificate requests of said installation component performable by the service function.

6. The service function as claimed in claim 4, wherein the service function performs a mutual coordination of a plurality of registration services of the technical installation, such that a unique allocation between an installation component of the technical installation and a registration service responsible for certificate requests of said installation component performable by the service function.

7. A control system of a technical installation, comprising: in particular manufacturing or process installation:
a software database for a public key infrastructure of a technical installation, which comprises at least one unique identification of installation components involved in the technical installation, the software database including information for at least one installation component, in relation to which a unique identification is stored in the software database comprising:
a) a device certificate issued by at least one of (i) a manufacturer of the installation component and (ii) an operator of the technical installation; and
b) at least one operational certificate, which has been issued for the installation component in the technical installation; and
a service function of a control system of a technical installation, which is established to function as an intermediary between at least one registration authority of the technical installation and at least one installation component during certificate requests by the at least one installation component;
wherein the at least one installation component is already part of the technical installation or is provided for integration into the technical installation;
wherein the service function acting as an intermediary at least involves identifying a registration authority of the technical installation responsible for the at least one installation component and forwarding a certificate request of the at least one installation component to the corresponding registration authority; and
wherein the registration authority is established and provided to forward the certificate request to a certification authority of the technical installation.

8. The control system as claimed in claim 7, wherein the technical installation comprises a manufacturing or process installation.

9. A technical installation in which at least one control system as claimed in claim 7 is implemented.

10. The technical installation as claimed in claim 9, wherein the technical installation comprises a manufacturing or process installation.

11. A method for applying for a certificate at a registration authority of a technical installation on a part of a component of the technical installation, the method comprising:
a) transferring a certificate request of an installation component to a registration authority, responsible for the installation component, of the technical installation via a service function;
b) performing, by the registration authority, an examination to determine whether at least one of (A) a certificate attached to the certificate request and issued by at least one of (i) a manufacturer of the installation component and (ii) an operator of the technical installation and (B) an operational certificate, which has been issued for the installation component in the technical installation, is stored in a software database;
c) performing, by the registration authority, an examination to determine whether a signature of the certification request is correct; and
d) performing, by the registration authority, an examination to determine whether at least one of (A) a public key of the certification request matches a public key contained in the certificate issued by at least one of (i) the manufacturer of the installation component and (ii) the operator of the technical installation and (B) an operational certificate, which has been issued for the installation component in the technical installation.

12. The method as claimed in claim 11, wherein the registration authority checks whether the installation component, which is making the certification request, is assignable to a particular company.

13. The method as claimed in claim 11, wherein the registration authority checks the type of installation component.

14. The method as claimed in claim 12, wherein the registration authority checks the type of installation component.

15. The method as claimed in claim 11, further comprising:
checking, by the registration authority, whether an intended use of the certificate request is correct.

16. The method as claimed in claim 12, further comprising:
checking, by the registration authority, whether an intended use of the certificate request is correct.

17. The method as claimed in claim 13, further comprising:
checking, by the registration authority, whether an intended use of the certificate request is correct.

18. A method for issuing a certificate on the part of a certification authority of a technical installation, the method comprising:
initially applying for the certificate as claimed in claim 11; and
issuing, subsequently, in a successful case, a corresponding certificate by the certification authority and transferred said issue certificate to a corresponding installation component and to a software database of the technical installation.
